(19) United States
(12) Patent Application Publication
(10) Pub. No.: US 2024/0142094 A1
(43) Pub. Date: May 2, 2024

(54) LAMP DEVICE

(71) Applicant: Qisda Corporation, Taoyuan City (TW)

(72) Inventors: Pin-Yuan SHENG, Taoyuan City (TW); Yu-Han CHENG, Taoyuan City (TW); Pai-Chun CHENG, Taoyuan City (TW)

(73) Assignee: Qisda Corporation, Taoyuan City (TW)

(21) Appl. No.: 18/384,930

(22) Filed: Oct. 30, 2023

(30) Foreign Application Priority Data
Nov. 2, 2022 (TW) 111141808

(51) Int. Cl. F21V 21/088; F21V 21/26

(52) U.S. Cl. CPC F21V 21/0885; F21V 21/26; F21W 2131/301

(57) ABSTRACT

A lamp device includes a light-emitting element, a first clamping element, a second clamping element, an outer cover and a counterweight. The first clamping element is connected with the light-emitting element. The outer cover is disposed on the first clamping element. The counterweight is connected to the outer cover and is adjacent to a connection between the first clamping element and the second clamping element. When the lamp device clamps a screen, the second clamping element abuts against a back surface of the screen.

This application claims the benefit of Taiwan application Serial No. 111141808, filed Nov. 2, 2022, the subject matter of which is incorporated herein by reference.

### FIELD OF THE INVENTION

The invention relates to a lamp device.

### BACKGROUND OF THE INVENTION

In order to illuminate working space on the desktop in front of the screen, the lamp device may clamp the screen for Illuminating the working space on the desktop in front of the screen. However, when the screen has a thin thickness, the lamp device which clamps the screen may easily fall off from the screen. Therefore, proposing a new lamp device to improve the aforementioned problems is an important issue for those in this technical field.

### SUMMARY OF THE INVENTION

In an embodiment of the invention, a lamp device is provided. The lamp device includes a light-emitting element, a first clamping element, a second clamping element and a counterweight. The first clamping element has a first end and a second end, wherein the first end is connected to the light-emitting element. The second clamping element has a third end and a fourth end, wherein the third end and the second end are connected at a connection. The counterweight is connected to the connection. A distance between the counterweight and the light-emitting element is equal to or greater than a distance between the connection and the light-emitting element; when the lamp device clamps a screen, the fourth end of the second clamping element abuts against a back surface of the screen.

In another embodiment of the invention, a lamp device is provided. The lamp device includes a light-emitting element, a first clamping element and a second clamping element. The first clamping element is connected to the light-emitting element. The second clamping element is connected to the first clamping element and includes a first clamping portion and a second clamping portion spaced apart from each other. When the lamp device clamps a screen, the first clamping portion and the second clamping portion respectively abut two different positions at a back surface of the screen.

In another embodiment of the invention, a lamp device is provided. The lamp device includes a light-emitting element, a first clamping element, a second clamping element and a counterweight. The first clamping element is connected to the light-emitting element. The counterweight is disposed on the second clamping element and adjacent to a connection between the first clamping element and the second clamping element. When the lamp device clamps a screen, the second clamping element abuts against a back surface of the screen.

In another embodiment of the invention, a lamp device is provided. The lamp device includes a light-emitting element, a first clamping element, a second clamping element and a counterweight. The first clamping element is connected to the light-emitting element, and the first clamping element includes an outer cover and a bottom portion. When the outer cover is combined with the bottom portion, an accommodation space is formed. The counterweight is connected to the outer cover and adjacent to a connection between the first clamping element and the second clamping element. When the lamp device clamps a screen, the second clamping element abuts against a back surface of the screen.

In another embodiment of the invention, a lamp device is provided. The lamp device includes a light-emitting element, a first clamping element, a second clamping element and a counterweight. The first clamping element includes a neck portion, a connection portion, a front clamping portion and a circuit module. The neck portion has a first end and a first connection end, wherein the first end is connected to the light-emitting element. The connection portion has a second connection end, wherein the second connection end is connected to the first connection end of the neck portion. The front clamping portion is connected to the connection portion. The circuit module is disposed on the neck portion. The second clamping element is connected to a second end of the connection portion. The counterweight is disposed adjacent to the second end. When the lamp device clamps a screen, the second clamping element abuts against a back surface of the screen, the front clamping portion abuts against a front surface of the screen, and the circuit module is located between the light-emitting element and the front clamping portion.

Numerous objects, features and advantages of the invention will be readily apparent upon a reading of the following detailed description of embodiments of the invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the invention will become more readily apparent to those ordinarily skilled in the art after reviewing the following detailed description and accompanying drawings, in which:

FIG. 1A illustrates a schematic diagram of an appearance of a lamp device according to an embodiment of the present invention;

FIG. 1B illustrates a schematic diagram of a side view of the lamp device in FIG. 1A;

FIGS. 2A and 2B illustrate schematic diagrams of exploded views of the lamp device in FIG. 1B viewed from different viewing angles (a light-emitting element is not illustrated);

FIG. 3 illustrates a schematic diagram of the lamp device in FIG. 1B clamping the screen;

FIG. 4 illustrates a schematic diagram of a lamp device according to another embodiment of the present invention;

FIGS. 5A and 5B illustrate schematic diagrams of exploded views of the lamp device in FIG. 4 viewed from different angles (the light-emitting element not illustrated);

FIG. 6 illustrates a schematic diagram of an exploded view of a lamp device according to another embodiment of the present invention;

FIG. 7 illustrated a schematic diagram of an exploded view of a lamp device according to another embodiment of the present invention;

FIGS. 8A to 8F illustrate schematic diagrams of the second clamping element according to various embodiments of the present invention; and

FIGS. 9 to 10 illustrate a relationship between the bearable weight of the lamp device and the thickness of the screen.

### DETAILED DESCRIPTION OF PREFERRED EMBODIMENTS

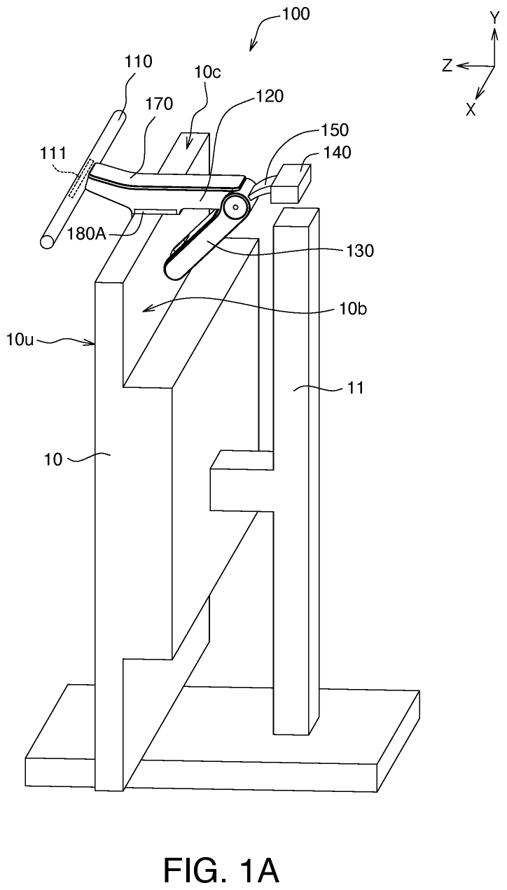

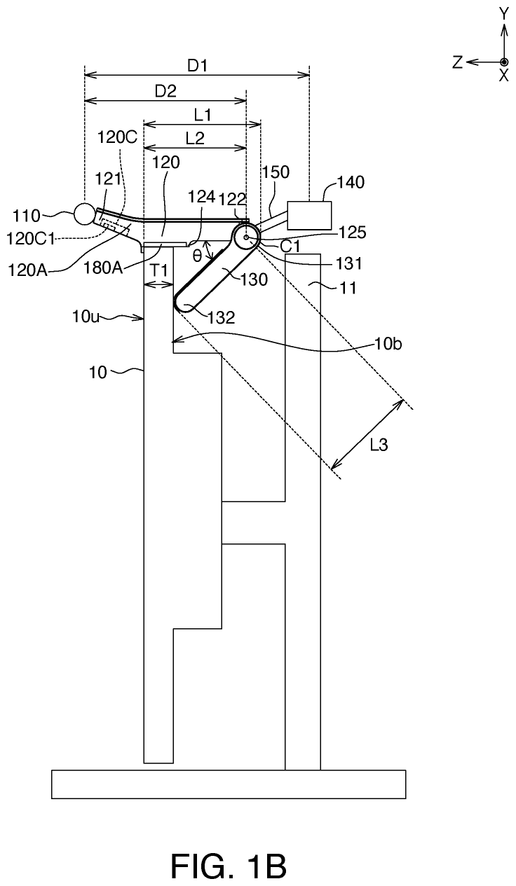

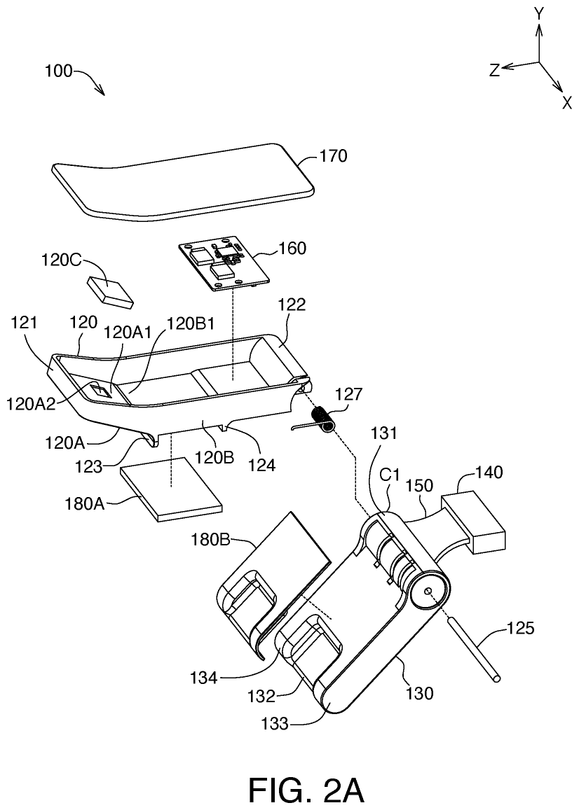

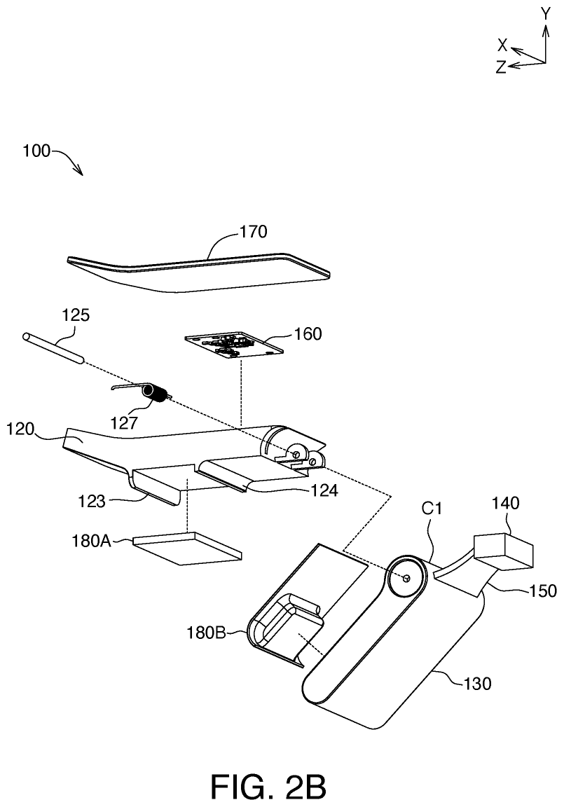

Referring to FIGS. 1A to 2B, FIG. 1A illustrates a schematic diagram of an appearance of a lamp device 100 according to an embodiment of the present invention, FIG. 1B illustrates a schematic diagram of a side view of the lamp device 100 in FIG. 1A, and FIGS. 2A and 2B illustrate schematic diagrams of exploded views of the lamp device 100 in FIG. 1B viewed from different viewing angles (a light-emitting element 110 is not illustrated).

As illustrated in FIGS. 1B and 2A, the lamp device 100 includes the light-emitting element 110, a first clamping element 120, a pivot shaft 125, an elastic element 127, a second clamping element 130, at least one counterweight 140, at least one connection element 150, a circuit board 160, the outer cover 170, a first buffer element 180A and a second buffer element 180B. The outer cover 170 herein may be a sub-element of the first clamping element 120, or the outer cover 170 and the first clamping element 120 may be components of the same level.

As illustrated in FIGS. 1B and 2A, the first clamping element 120 has a first end 121 and a second end 122, and the first end 121 is connected to the light-emitting element 110. The second clamping element 130 has a third end 131 and a fourth end 132, wherein the third end 131 and the second end 122 are connected to a connection C1. Counterweight 140 is connected to connection C1. When the lamp device 100 clamps the screen 10, the fourth end 132 of the second clamping element 130 abuts against a back surface 10b of the screen 10. A distance D1 between the counterweight 140 and the light-emitting element 110 is equal to or greater than a distance D2 between the connection C1 and the light-emitting element 110. Compared with the counterweight 140 being closer to the light-emitting element 110 than the connection C1, due to the counterweight 140 being further away from the light-emitting element 110, it may increase a force of the lamp device 100 against the back 10b of the screen 10, and accordingly it may prevent the lamp device 100 and the screen 10 from being detached from each other. In particular, when the screen 10 is a thin screen, the lamp device 100 may exert sufficient clamping force to clamp the screen 10.

As illustrated in FIG. 1B, the connection C1 is, for example, a part of the first clamping element 120 or a part of the second clamping element 130. For example, the connection C1 includes the second end 122 of the first clamping element 120 and the third end 131 of the second clamping element 130. In the present embodiment, the first clamping element 120 and the second clamping element 130 may rotate relatively but not slide relative to each other, that is, the connection C1 only has a degree of freedom (DOF) of rotation but not a degree of freedom of sliding. In another embodiment, the first clamping element 120 and the second clamping element 130 may slide relative to each other but not rotate relative to each other, and such design may also clamp the screen 10. In such example, the connection C1 only has the degree of freedom of sliding but not the degree of freedom of rotation. In other embodiments, the first clamping element 120 and the second clamping element 130 may slide relative to each other and rotate relative to each other, and such design may also clamp the screen 10. In this example, the connection C1 has both the degree of freedom of sliding and the degree of freedom of rotation.

As illustrated in FIGS. 1A to 1B, the light-emitting element 110 is detachably connected to the first clamping element 120. For example, the light-emitting element 110 and the first clamping element 120 may be connected through magnetic attraction, but it is not intended to limit the embodiment of the present invention.

As illustrated in FIG. 1B, the pivot shaft 125 passes through the first clamping element 120 and the second clamping element 130. The pivot shaft 125 is tightly matched with one of the first clamping element 120 and the second clamping element 130, and is loosely matched with the other of the first clamping element 120 and the second clamping element 130, so that the first clamping element 120 and the second clamping element 130 are connected to each other and may rotate relative to each other. The aforementioned connection C1 may also include a pivot shaft 125.

As illustrated in FIG. 1B, the elastic element 127 connects the first clamping element 120 with the second clamping element 130. For example, one end of the elastic element 127 is fixed to the first clamping element 120 and the other end is fixed to the second clamping element 130. As a result, when the first clamping element 120 and the second clamping element 130 rotate relative to each other, the elastic element 127 deforms to store elastic potential energy. When the first clamping element 120 and the second clamping element 130 are released, the elastic element 127 releases the elastic potential energy and returns to its original position. In an embodiment, the elastic element 127 is, for example, a torsion spring.

As illustrated in FIGS. 1B and 2A to 2B, the first clamping element 120 includes a front clamping portion 123. The second clamping element 130 includes a first clamping first clamping portion 133 and a second clamping portion 134 spaced apart from each other. When the lamp device 100 clamps the screen 10, the first clamping first clamping portion 133 and the second clamping portion 134 of the second clamping element 130 respectively abut against two different positions at the back surface 10b, and the front clamping portion 123 of the first clamping element 120 abuts against a position at the front surface 10u (for example, a display surface) of the screen 10. As a result, the lamp device 100 clamps three points at the screen 10, wherein the three-point clamping may increase the stability of the combination between the lamp device 100 and the screen 10.

As illustrated in FIG. 2A, the first clamping element 120 further includes a neck portion 120A, a connection portion 120B and a circuit module 120C. The neck portion 120A has a first end 121 and a first connection end 120A1. The first end 121 is connected to the light-emitting element 110. The connection portion 120B has a second connection end 12061. The second connection end 120B1 is connected to the first connection end 120A1 of the neck portion 120A. The connection portion 120B is connected to the front clamping portion 123. The circuit module 120C is provided on the neck portion 120A. The second clamping element 130 is connected to the second end 122 of the connection portion 120B. As illustrated in FIG. 1B, the circuit module 120C is at least exposed from the surface of the neck portion 120A that is in the same direction with the display surface 10u. For example, as illustrated in FIG. 2A, the neck portion 120A has a light-transmitting area 120A2, and the circuit module 120C is at least partially exposed from the light-transmitting area 120A2. As illustrated in FIGS. 1A and 1B, the light-emitting element 110 further includes a control circuit 111, and the circuit module 120C further includes a sensing circuit 120C1 electrically connected to the control circuit 111. The control circuit 111 may control the light-emitting unit (e.g., a light-emitting diode) of the light-emitting element 110 to emit light. The sensing circuit 120C1 includes, for example, an object detector, and the object detector may detect whether there is a user in front of the screen 10. The object detector is, for example, an infrared detector or an ultrasonic detector. The control circuit 111 may control the light-emitting mode of the light-emitting unit of the light-emitting element 110 according to the sensing signal of the sensing circuit 120C1, such as non-lighting or light-emitting, light-emitting brightness, lighting effect and/or light-emitting color temperature, etc.

In an embodiment, the light-emitting mode of the light-emitting unit of the light-emitting element 110 is completely controlled according to the sensing circuit 120C1. In this example, the circuit board 160 may also be selectively omitted. In another embodiment, the sensing signal of the sensing circuit 120C1 may be transmitted to the circuit board 160, and then the circuit board 160 controls the light-emitting mode of the light-emitting unit of the light-emitting device 110. In summary, the signal that determines the light-emitting mode of the light-emitting unit that controls the light-emitting element 110 may be emitted by the sensing circuit 120C1 or the circuit board 160, but the related circuit may also be disposed in the light-emitting element 110.

In addition, the structures of the aforementioned light-emitting element 110 and the first clamping element 120 may be applied to the light-emitting element and the first clamping element of the lamp device in other embodiment of this invention, and it will not be described again here.

The density of the counterweight 140 is greater than the density of the first clamping element 120 and/or the density of the second clamping element 130, so the counterweight 140 may provide sufficient weight. In terms of materials, the counterweight 140 may be formed of metal or plastic, for example, and the first clamping element 120 and/or the second clamping element 130 may be formed of plastic, for example. In an embodiment, the second clamping element 130 is, for example, a metal element, and its density is, for example, the same as that of the counterweight 140, so that the second clamping element 130 and the counterweight 140 are regarded as an integral counterweight.

As illustrated in FIGS. 2A to 2B, the connection element 150 may connect the counterweight 140 with the second clamping element 130. In the present embodiment, the connection element 150 extends in a direction away from the connection C1. In addition, the connection element 150, the counterweight 140 and the second clamping element 130 may be integrally formed or integrated into single piece. In another embodiment, the connection element 150 may connect the counterweight 140 with the first clamping element 120, and extend in a direction away from the connection C1. The connection element 150, the counterweight 140 and the first clamping piece 120 may be integrally formed or integrated into single piece.

As illustrated in FIGS. 2A and 2B, the circuit board 160 may be disposed inside the first clamping element 120 and adjacent to the second end 122. When the light-emitting element 110 is connected to the first clamping element 120, the circuit board 160 is electrically connected to the light-emitting element 110 for controlling the light-emitting mode of the light-emitting element 110, such as turning-on, turning-off, brightness adjustment, lighting-effect adjustment, etc. In addition, the circuit board 160 may also be disposed adjacent to the second end 122, and accordingly the circuit board's own weight may act as a counterweight.

As illustrated in FIGS. 2A and 2B, the outer cover 170 may be disposed above the first clamping element 120 and cover the internal components of the first clamping element 120, such as the circuit board 160.

As illustrated in FIGS. 2A and 2B, the first buffer element 180A is disposed on the first clamping element 120. For example, the first buffer element 180A is connected with the first clamping element 120 by snapping, adhering, or other permanent or temporary fixing technologies. The first clamping element 120 further includes a position-limited element 124, and the first buffer element 180A is located between the front clamping portion 123 and the position-limited element 124. The first buffer element 180A is softer than the first clamping element 120 in texture. When the lamp device 100 clamps the screen 10, the first buffer element 180A abuts against a top surface 10c (the top surface 10c is illustrated in FIG. 1A) of the screen 10. In other words, the first clamping element 120 abuts against the top surface 10c of the screen 10 through the first buffer element 180A for preventing the screen 10 from being pinched. In terms of material, the first buffer element 180A may be formed of, for example, rubber.

As illustrated in FIGS. 2A to 2B, the second buffer element 180B may be disposed on the second clamping element 130. For example, the second buffer element 180B is connected with the second clamping element 130 by snapping, adhering, or other permanent or temporary fixing technologies. The second buffer element 180B is softer than the second clamping element 130 in texture. When the lamp device 100 clamps the screen 10, the second buffer element 180B abuts against the back surface 10b of the screen 10. In other words, the second clamping element 130 abuts against the back surface 10b (the back surface 10b is illustrated in FIG. 1A) of the screen 10 through the second buffer 180B for preventing the screen 10 from being pinched. In terms of material, the second buffer element 180B may be formed of, for example, rubber.

As illustrated in FIG. 1B, the first clamping element 120 has a first length L1. The first clamping element 120 has a second length L2, and the second length L2 is the distance between the pivot shaft 125 and the front clamping portion 123. The first length L1 ranges between, for example, 75 millimeters (mm) and 85 mm, and the second length L2 ranges between, for example, 65 mm and 75 mm, which may prevent the lamp device 100 from interfering with a support post 11 behind the screen 10, wherein the support post 11 is pivotally connected to the screen 10. The second clamping element 130 has a third length L3, and the third length L3 is the distance between the pivot shaft 125 and the fourth end 132. The second length L2 and the third length L3 satisfy the following formulas (1) and (2). In formula (1), n ranges between, for example, 60 mm and 65 mm, which may be applied to most or all curved screens in the market (the lamp device 100 does not interfere with the back surface of the curved screen). The lamp device 100 may be applied to the screen 10 having a thickness T1, wherein the thickness T1 may range between, for example, 5 mm to 120 mm, for example. In an embodiment, the lamp device 100 is more suitable for screens 10 with smaller thickness. As illustrated in the following formula (2), θ represents an angle between the first clamping element 120 and the second clamping element 130, wherein the thickness T1=T0 may range between, for example, 3 mm and 5 mm.

L3<n (1)

L2−L3×cos θ<T0 (2)

Although the lamp device 100 in the aforementioned embodiments includes the counterweight 140 as an example; however, in another embodiment, the lamp device 100 may omit the counterweight 140 and the connection element 150.

Although the counterweight 140 of the lamp device 100 in the aforementioned embodiment is disposed outside the first clamping element 120 and the second clamping element 130. In another embodiment, the counterweight 140 may also be disposed on the pivot shaft. 125. Alternatively, the counterweight 140 and the pivot shaft 125 may be integrated into single piece. In an approach, the density of the pivot shaft 125 may be increased or the material of the pivot shaft 125 may be changed to become a counterweight. In terms of material, the pivot shaft 125 may be formed of, for example, metal, plastic, or other materials.

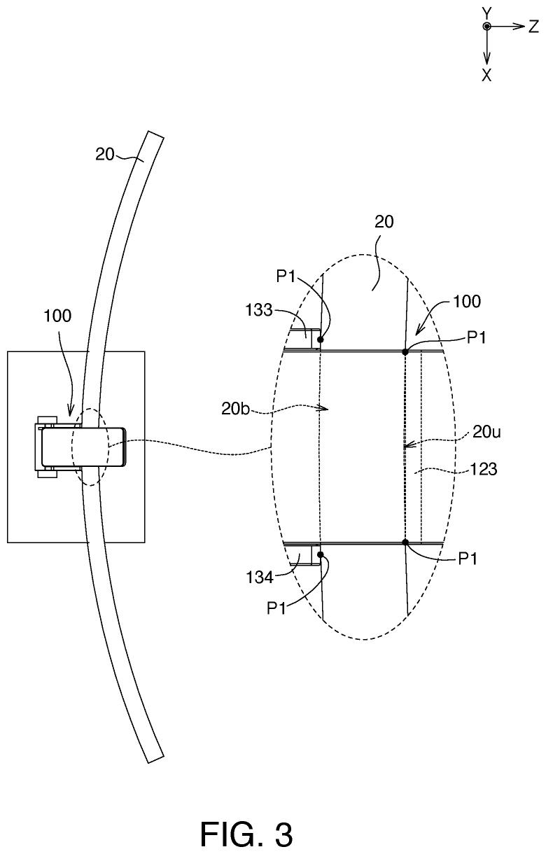

Referring to FIG. 3, FIG. 3 illustrates a schematic diagram of the lamp device 100 in FIG. 1B clamping the screen 20. The lamp device 100 clamps the screen 20, and the screen 20 is, for example, a curved screen. When the lamp device 100 clamps the curved screen, the first clamping first clamping portion 133 and the second clamping first clamping portion 134 of the second clamping element 130 respectively abut against two different position points at the back surface 10b, and the front clamping portion 123 of the first clamping element 120 abuts against two different position points at the front surface 20u of the screen 20. As a result, the lamp device 100 clamps the four position points P1 of the screen 20. The four-point clamping may increase the stability of the combination between the lamp device 100 and the curved screen.

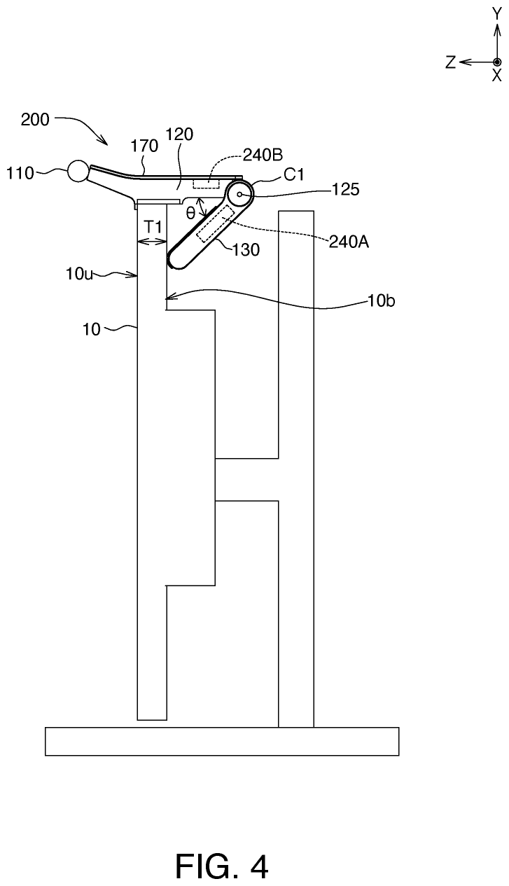

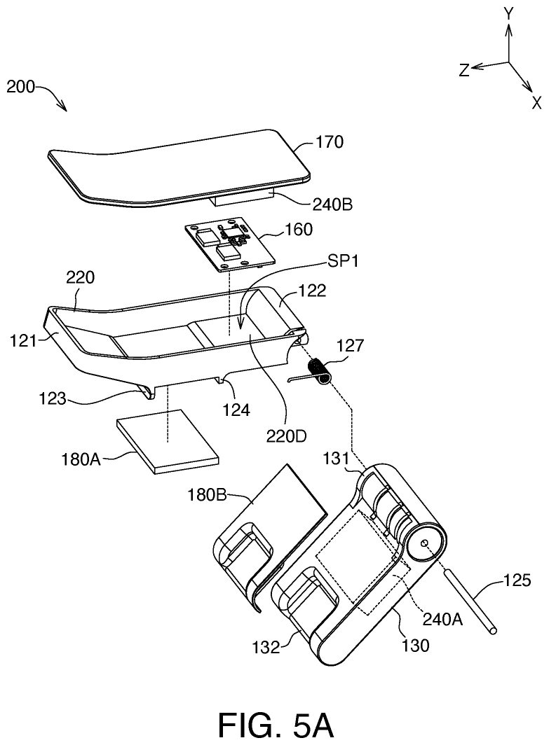

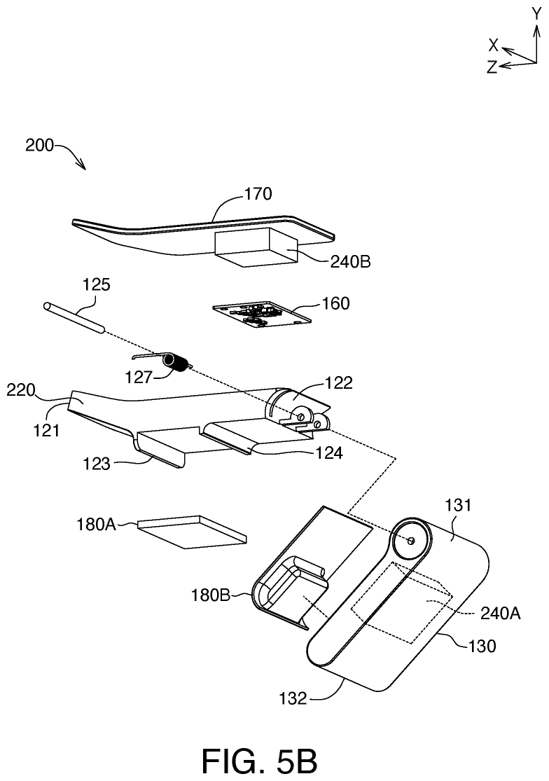

Referring to FIGS. 4, 5A and 5B, FIG. 4 illustrates a schematic diagram of a lamp device 200 according to another embodiment of the present invention, and FIGS. 5A and 5B illustrate schematic diagrams of exploded views of the lamp device 200 in FIG. 4 viewed from different angles (the light-emitting element 110 not illustrated).

As illustrated in FIGS. 4, 5A and 5B, the lamp device 200 includes the light-emitting element 110, a first clamping element 220, the pivot shaft 125, the elastic element 127, the second clamping element 130, at least one first counterweight 240A, and at least one second counterweight 240B, the circuit board 160, the outer cover 170, the first buffer element 180A and the second buffer element 180B.

As illustrated in FIG. 4, the first clamping element 220 is connected to the light-emitting element 110. When the lamp device 100 clamps the screen 10, the second clamping element 130 abuts against the back surface 10b of the screen 10. The first counterweight 240A is disposed on the second clamping element 130 and adjacent to the connection C1 between the first clamping element 220 and the second clamping element 130. As a result, the first counterweight 240A may increase the force of the lamp device 200 abutting against the back surface 10b of the screen 10, so that the lamp device 100 and the screen 10 are not easily separated from each other. Especially, when the screen 10 is a thin screen, the lamp device 200 may exert sufficient clamping force to clamp the screen 10.

The thickness of the thin screen in the embodiment of the present invention is, for example, equal to or less than 20 mm, such as 19 mm, 18 mm, 17 mm, 16 mm, 15 mm, 14 mm, 13 mm, 12 mm, 11 mm, 10 mm, 9 mm, 8mm, 7 mm, 6 mm, 5 mm, 4 mm, 3 mm, 2 mm, 1 mm, or less.

The first clamping element 220 of this embodiment has the structures the same as or similar to that of the aforementioned first clamping element 120. One of the differences is that the first clamping element 220 may selectively omit the aforementioned circuit module 120C and the light-transmitting area 120A2.

As illustrated in FIGS. 5A to 5B, the second counterweight 240B is disposed on the outer cover 170 and adjacent to the connection C1 of the first clamping element 120 and the second clamping element 130. As a result, the second counterweight 240B may increase the force of the lamp device 200 abutting against the back surface 10b of the screen 10, so that the lamp device 100 and the screen 10 are not easily separated from each other. In particular, when the screen 10 is a thin screen, the lamp device 200 may also exert sufficient clamping force to clamp the screen 10; in such present embodiment, the circuit board 160 may substantially overlap with the second counterweight 240B in position, and the circuit board 160 may be adjacent to the connection C1. For example, the first clamping element 220 further includes a bottom portion 220D. When the outer cover 170 and the bottom portion 220D are combined, an accommodation space SP1 is formed between the circuit board 160 and the second counterweight 240B. When the outer cover 170 and the first clamping element 220 are combined, the circuit board 160 and the second counterweight 240B are located within the accommodation space SP1, and overlap up and down. In addition, the circuit board 160 and the second counterweight 240B may be in contact with or spaced apart from each other.

In another embodiment, the second counterweight 240B and the circuit board 160 may be integrated into one module and disposed adjacent to the connection C1.

In another embodiment, the lamp device 200 may omit one of the first counterweight 240A and the second counterweight 240B.

In other embodiments, the first counterweight 240A may be disposed on the pivot shaft 125; or, the first counterweight 240A may be integrated into the pivot shaft 125 (integrated into single piece). In this example, the first counterweight (the pivot shaft 125) is equivalent to pivotally connecting the first clamping element 220 and the second clamping element 130.

In addition, the first counterweight 240A and the second clamping element 130 may be integrally formed, or may be formed separately and then combined together through adhering, snap-fitting, other permanent or temporary fixing technologies. The second counterweight 240B and the outer cover 170 may be integrally formed, or may be formed separately and then combined together through adhering, snap-fitting, other permanent or temporary fixing technologies.

In terms of density, the density of the first counterweight 240A is greater than the density of the second clamping element 130, and the density of the second counterweight 240B is greater than the density of the first clamping element 220. In terms of materials, the first counterweight 240A is formed of, for example, metal or plastic, the second clamping element 130 is formed of, for example, plastic, the second counterweight 240B is formed of, for example, metal or plastic, and the first clamping element 220 is formed of, for example, plastic.

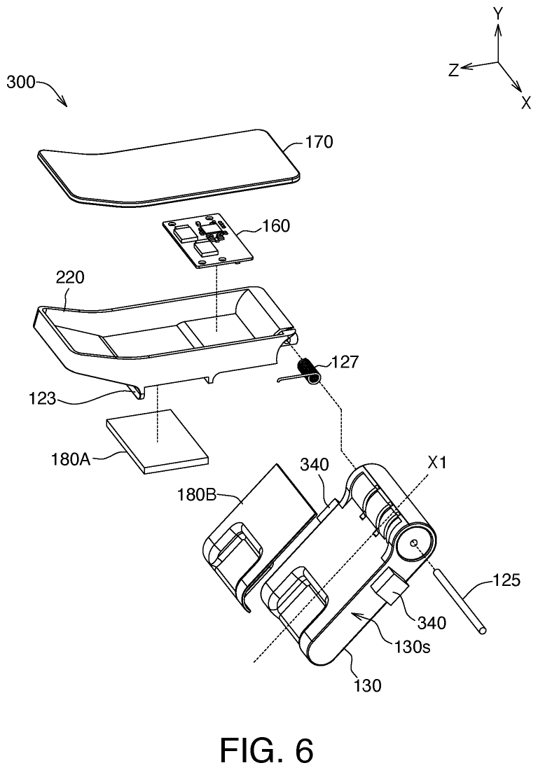

Referring to FIG. 6, FIG. 6 illustrates a schematic diagram of an exploded view of a lamp device 300 according to another embodiment of the present invention. The lamp device 300 includes the light-emitting element 110, the first clamping element 120, the pivot shaft 125, the elastic element 127, the second clamping element 130, at least one counterweight 340, the circuit board 160, the outer cover 170, the first buffer element 180A and the second buffer element 180B.

As illustrated in FIG. 6, the first clamping element 220 is connected to the light-emitting element 110. When the lamp device 300 clamps the screen 10, the second clamping element 130 abuts against the back surface 10b of the screen 10. The counterweight 340 is disposed on an outer lateral surface 130s of the second clamping element 130 and protrudes relative to the outer lateral surface 130s. The counterweight 340 may increase the force of the lamp device 300 abutting against the back surface 10b of the screen 10. At this time, the clamping force of the elastic element 127 makes the lamp device 300 and the screen 10 prevent from being further easily separated from each other. Especially, when the screen 10 (illustrated in FIG. 1B) is a thin screen, the lamp device 300 may also exert sufficient clamping force to clamp the screen 10. In addition, the counterweight 340 may be disposed adjacent to the connection C1 between the first clamping element 220 and the second clamping element 130, or directly disposed at the connection C1 and it may increase the stability of the combination of the lamp device 300 and the screen 10. In an embodiment, two counterweights 340 are respectively disposed on opposite two sides of the second clamping element 130 so that a center of gravity of the second clamping element 130 is as close as possible to a center line X1, and accordingly the force applying to the screen 10 by the lamp device 300 is more evenly distributed.

In an embodiment, the counterweight 340 and the second clamping element 130 may be integrally formed, or may be formed separately and then combined together through adhering, snap-fitting, other permanent or temporary fixing technologies. The counterweight 340 has the features similar to or the same as that of the aforementioned counterweight 140, such as structure, material, and/or density, which will not be repeated again here.

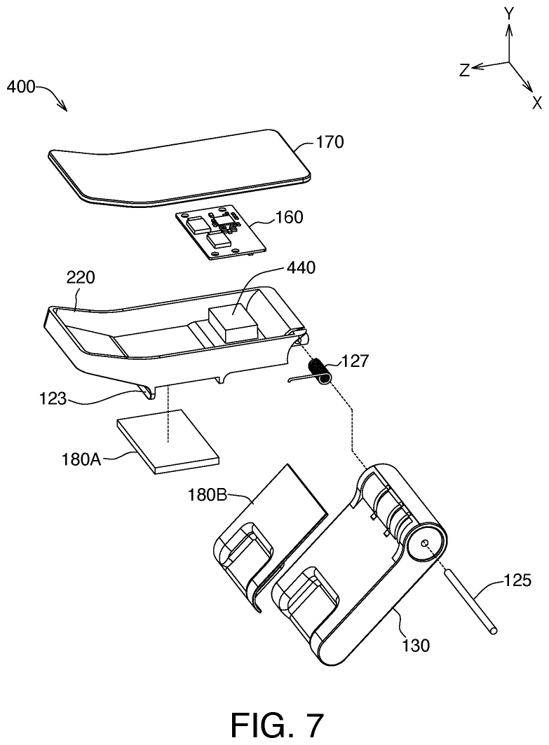

Referring to FIG. 7, FIG. 7 illustrated a schematic diagram of an exploded view of a lamp device 400 according to another embodiment of the present invention. The lamp device 400 includes the light-emitting element 110, a first clamping element 220, the pivot shaft 125, the second clamping element 130, at least one counterweight 440, the circuit board 160, the outer cover 170, the first buffer element 180A and the second buffer element 180B.

As illustrated in FIG. 7, the first clamping element 220 is connected to the light-emitting element 110. When the lamp device 400 clamps the screen 10, the second clamping element 130 abuts against the back surface 10b of the screen 10. The counterweight 440 is disposed within the first clamping element 220. The counterweight 440 may increase the force of the lamp device 400 against the back surface 10b of the screen 10 (the screen 10 is illustrated in FIG. 1B), so that the lamp device 400 and the screen 10 are not easily separated from each other. Especially, when the screen 10 is the thin screen, the lamp device 400 may exert sufficient clamping force to clamp the screen 10. The counterweight 440 is disposed adjacent to the connection C1 of the first clamping element 220 and the second clamping element 130, which may increase the stability of the combination of the lamp device 400 and the screen 10. In addition, the counterweight 440 may be disposed under the circuit board 160 or integrated with the circuit board 160 into one module disposed adjacent to the connection C1.

Different from the second counterweight 240B in FIG. 4, the counterweight 440 and the outer cover 170 of the embodiment of the present invention are detachably disposed. Furthermore, when the outer cover 170 is combined with the first clamping element 220, the counterweight 440 and the outer cover 170 may be connected or kept apart. When the outer cover 170 is detached from the first clamping element 220, the outer cover 170 and the counterweight 440 may be separated from each other.

In an embodiment, the counterweight 440 and the first clamping element 220 may be integrally formed, or may be formed separately and then combined together through adhering, snap-fitting, other permanent or temporary fixing technologies. The counterweight 440 has the features (for example, structure, material, density, etc.) similar to or the same as that of the aforementioned counterweight 140, and it will not be repeated again here.

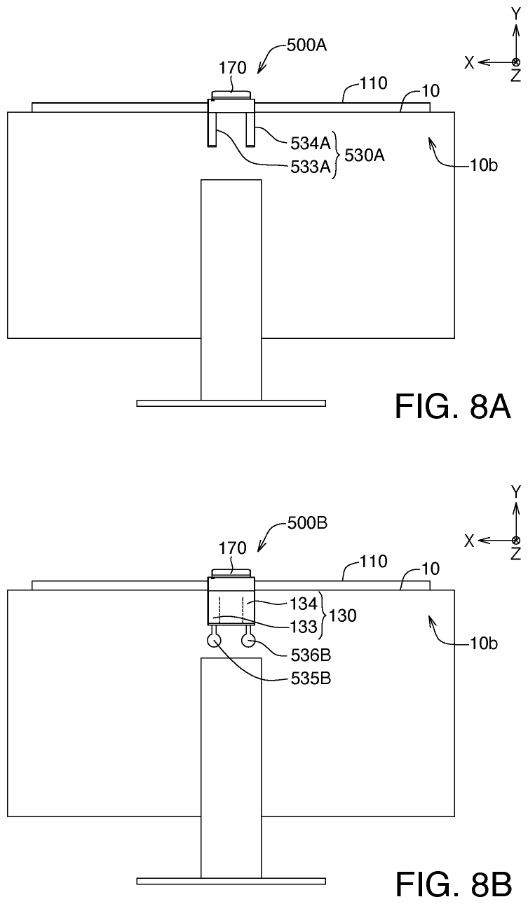

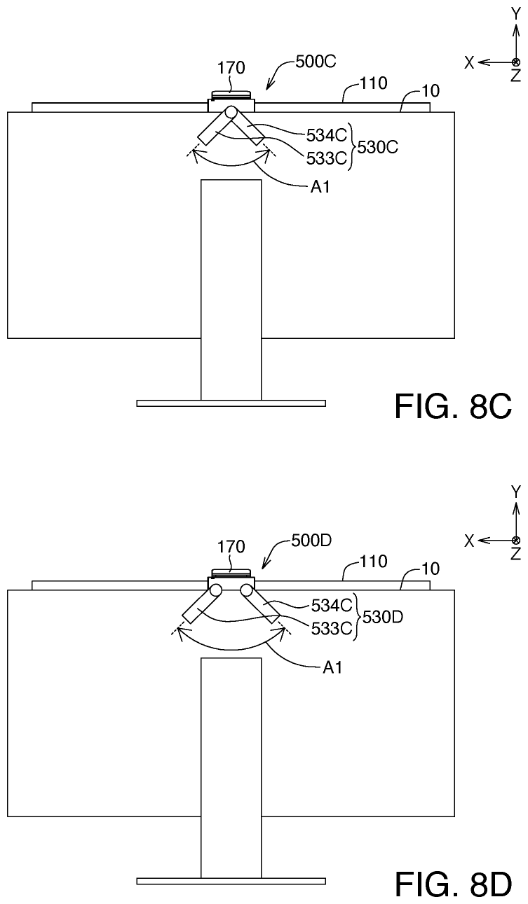

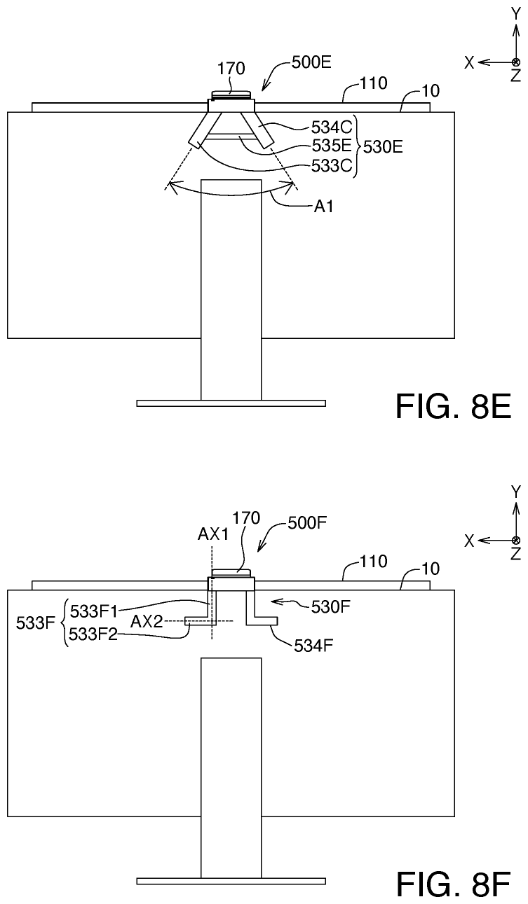

Referring to FIGS. 8A to 8F, FIGS. 8A to 8F illustrate schematic diagrams of the second clamping element according to various embodiments of the present invention.

As illustrated in FIG. 8A, a lamp device 500A includes the light-emitting element 110, the first clamping element 120 (not illustrated), the pivot shaft 125 (not illustrated), the second clamping element 530A, and at least one first counterweight 240A. (not illustrated), at least one second counterweight 240B (not illustrated), the circuit board 160 (not illustrated), the outer cover 170, the first buffer element 180A (not illustrated) and the second buffer element 180B (not illustrated) shown). The lamp device 500A has technical features (for example, structure, material, etc.) similar to or the same as that of the aforementioned lamp device 200. The difference lies in that the second clamping element 530A of the lamp device 500A has a different structure. In addition, the second clamping element 530A may also be applied to the lamp device in other embodiment of the present invention or replace the second clamping element in other embodiment of the present invention. In other embodiment, the first clamping element 120 may be replaced by the first clamping element 220.

Furthermore, the second clamping element 530A includes a first clamping portion 533A and a second clamping portion 534A. The first clamping portion 533A and the second clamping portion 534A are slidably and pivotally connected to the first clamping element 120 for changing the relative distance between the first clamping portion 533A and the second clamping portion 534A along the long axis X of the light-emitting element 110 and/or the axis Z. In another embodiment, the first clamping portion 533A and the second clamping portion 534A are further rotatably pivoted to the first clamping element 120 (not illustrated). In the present embodiment, the long axis X, the axis Z and the axis Y are, for example, perpendicular to each other.

As illustrated in FIG. 8B, a lamp device 500B includes the light-emitting element 110, the first clamping element 120 (not illustrated), the pivot shaft 125 (not illustrated), the second clamping element 130, at least one first counterweight 240A. (not illustrated), at least one second counterweight 240B (not illustrated), the circuit board 160 (not illustrated), the outer cover 170, the first buffer element 180A (not illustrated), the second buffer element 180B (not illustrated), a first abutting portion 535B and a second abutting portion 536B. The lamp device 500B has technical features (for example, structure, material, etc.) similar to or the same as that of the aforementioned lamp device 200, and the difference is that the lamp device 500B further includes the first abutting portion 535B and the second abutting portion 536B. In addition, the first abutting portion 535B and the second abutting portion 536B may also be applied to lamps in other embodiments of the present invention. In other embodiments, the first clamping element 120 may be replaced by the first clamping element 220.

Furthermore, the first abutting portion 535B is connected to the end of the first clamping portion 133, and the second abutting portion 536B is connected to the end of the second clamping portion 134. When the lamp device 500B clamps the screen 10, the first abutting portion 535B and the second abutting portion 536B respectively abut the back surface 10b of the screen 10. In the present embodiment, the first abutting portion 535B and the second abutting portion 536B are, for example, spherical portions.

As illustrated in FIG. 8C, a lamp device 500C includes the light-emitting element 110, the first clamping element 120 (not illustrated), the pivot shaft 125 (not illustrated), the second clamping element 530C, and at least one first counterweight 240A. (not illustrated), at least one second counterweight 240B (not shown), the circuit board 160 (not illustrated), the outer cover 170, the first buffer element 180A (not illustrated) and the second buffer element 180B (not illustrated). The lamp device 500C has technical features (for example, structure, material, etc.) similar to or the same as that of the aforementioned lamp device 200, and the difference is in that the second clamping element 530C of the lamp device 500C has a different structure. In addition, the second clamping element 530C may also be applied to the lamps in other embodiment of the present invention or replace the second clamping element in other embodiment of the present invention. In other embodiment, the first clamping element 120 may be replaced by the first clamping element 220.

Furthermore, the second clamping element 530C includes a first clamping portion 533C and a second clamping portion 534C. The first clamping portion 533C and the second clamping portion 534C are rotatably pivoted to the first clamping element 120 for changing an angle Al between the first clamping portion 533C and the second clamping portion 534C.

As illustrated in FIG. 8D, a lamp device 500D includes the light-emitting element 110, the first clamping element 120 (not illustrated), a pivot shaft 125 (not illustrated), a second clamping element 530D, and at least one first counterweight 240A. (not illustrated), at least one second counterweight 240B (not illustrated), the circuit board 160 (not illustrated), the outer cover 170, the first buffer element 180A (not illustrated) and the second buffer element 180B (not illustrated). The lamp device 500D has technical features (for example, structure, material, etc.) similar to or the same as that of the aforementioned lamp device 500C, and the difference is in that the second clamping element 530D of the lamp device 500D has a different structure. In addition, the second clamping element 530D may also be applied to the lamp device in other embodiment of the present invention or replace the second clamping element in other embodiment of the present invention. In other embodiment, the first clamping element 120 may be replaced by the first clamping element 220.

Furthermore, the second clamping element 530D includes a first clamping portion 533C and a second clamping portion 534C. The first clamping portion 533C and the second clamping portion 534C are rotatably pivoted to the first clamping element 120 for changing the angle Al between the first clamping portion 533C and the second clamping portion 534C. Different from the aforementioned second clamping element 530C, the first clamping portion 533C and the second clamping portion 534C of the second clamping element 530D are pivoted to two different positions of the first clamping element 120 respectively.

As illustrated in FIG. 8E, a lamp device 500E includes the light-emitting element 110, the first clamping element 120 (not illustrated), the pivot shaft 125 (not illustrated), a second clamping element 530E, and at least one first counterweight 240A. (not illustrated), at least one second counterweight 240B (not illustrated), the circuit board 160 (not illustrated), the outer cover 170, the first buffer element 180A (not illustrated) and the second buffer element 180B (not illustrated). The lamp device 500E has technical features (for example, structure, material, etc.) similar to or the same as that of the aforementioned lamp device 500D, and the difference is in that the second clamping element 530E of the lamp device 500E has a different structure. In addition, the second clamping element 530E may also be applied to the lamp device in other embodiment of the present invention or replace the second clamping element in other embodiment of the present invention. In other embodiment, the first clamping element 120 may be replaced by the first clamping element 220.

Furthermore, the second clamping element 530E includes the first clamping portion 533C, the second clamping portion 534C and a connection portion 535E. A fixed acute angle is included between the first clamping portion 533C and the second clamping element 534C. For example, the connection portion 535E connects the first clamping portion 533C with the second clamping portion 534C to fix the angle Al between the first clamping portion 533C and the second clamping portion 534C. The angle Al is, for example, an acute angle.

As illustrated in FIG. 8F, a lamp device 500F includes the light-emitting element 110, the first clamping element 120 (not illustrated), the pivot shaft 125 (not illustrated), a second clamping element 530F, and at least one first counterweight 240A. (not illustrated), at least one second counterweight 240B (not illustrated), the circuit board 160 (not illustrated), the outer cover 170, the first buffer element 180A (not illustrated) and the second buffer element 180B (not illustrated). The lamp device 500F has technical features (for example, structure, material, etc.) similar to or the same as that of the aforementioned lamp device 200, and the difference is in that the second clamping element 530F of the lamp device 500F has a different structure. In addition, the second clamping element 530F may also be applied to the lamp device of other embodiment of the present invention or replace the second clamping element in other embodiment of the present invention. In other embodiment, the first clamping element 120 may be replaced by the first clamping element 220.

Furthermore, the second clamping element 530F includes a first clamping portion 533F and a second clamping portion 534F. The first clamping portion 533F includes a connected first sub-clamping portion 533F1 and a second sub-clamping portion 533F2. The first sub-clamping portion 533F1 is rotatably pivoted to the first clamping element 120 around a first axis AX1, and the second sub-clamping portion 533F2 is connected to the first sub-clamping portion 533F1 along a second axis AX2, wherein the second axis AX2 is substantially perpendicular to the first axis AX1. As a result, the first sub-clamping portion 533F1 may rotate around the first axis AX1 to drive the second sub-clamping portion 533F2 to rotate so that its end abuts against a point at the back surface of the screen 10. Based on the structure of the first clamping portion 533F, the second clamping element 530F is particularly suitable for the curved screen. In addition, the second clamping portion 534F includes the structure similar to or the same as that of the first clamping portion 533F, and it will not be repeated again here.

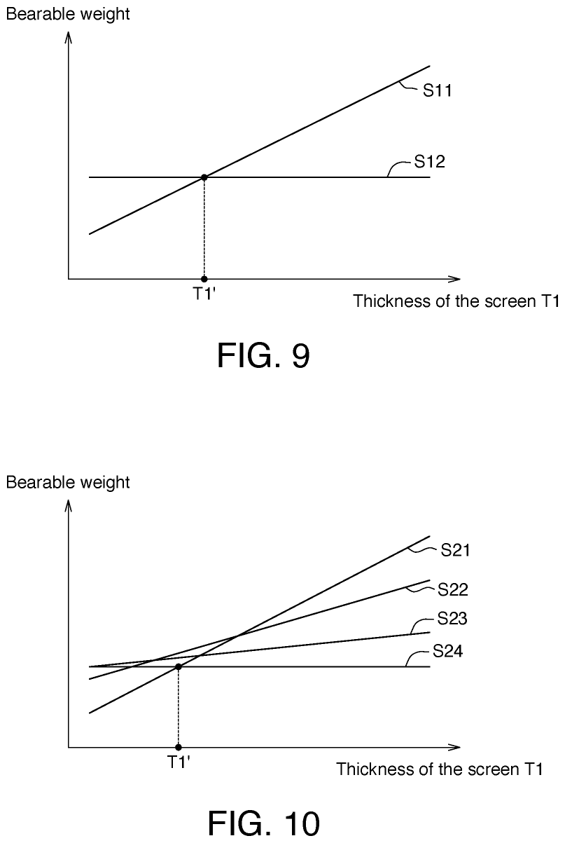

Referring to FIGS. 9 to 10, FIGS. 9 to 10 illustrate a relationship between the bearable weight of the lamp device and the thickness of the screen.

As illustrated in FIG. 9, the curve S11 represents a relationship between the bearable weight of the conventional lamp device and the thickness of the screen, and the curve S12 represents a relationship between the bearable weight of the lamp device 200 and the thickness of the screen. The greater the bearable weight is, the greater the clamping force of the lamp device to the screen is, and the higher the stability of the combination between the lamp device and the screen is. The value of the bearable weight depends on the weight of the light-emitting element 110, the weight of the lamp device and/or the weight of the counterweight (e.g., weight and/or position), and it is not limited by the embodiment of the present invention. Compared with the conventional lamp device (curve S11), the lamp device 200 (curve S12) of the embodiment of the present invention has the stable clamping force on the thin screen (for example, the thickness is equal to or less than T1′, and T1′ is, for example, 20 mm). Other lamps according to the embodiments of the present invention have similar technical effects and it will not be repeated again here.

As illustrated in FIG. 10, the curve S21 represents a relationship between the bearable weight of the conventional lamp device and the thickness of the screen, the curve S22 represents the relationship between the bearable weight of the lamp device 200 (but the second counterweight 240B is omitted) and the thickness of the screen, and the curve S23 represents the relationship between the bearable weight of the lamp device 200 (the first counterweight 240A is adjacent to the connection (or rotating axis) C1) and the thickness of the screen, and the curve S24 represents the relationship between the bearable weight of the lamp device 200 (but the first counterweight 240A is omitted) and the thickness of the screen.

Compared with the conventional lamp device (curve S21), the lamp device (curves S22 to S24) of the embodiment of the present invention has stable clamping force for thin screen (for example, the thickness is equal to or less than T1′). In addition, when the counterweight is closer to the connection C1 of the lamp, the clamping force of the lamp device on the screen becomes higher.

In summary, the embodiment of the present invention provides a lamp. In an embodiment, the first clamping element and the second clamping element are connected at a connection for relative sliding and/or rotating. At least one counterweight may be disposed on at least one of the first clamping element and the second clamping element. Alternatively, at least one counterweight may be directly or indirectly connected to the first clamping element. Alternatively, at least one counterweight may be disposed on the inside or the outside of the clamping element (the first clamping element and/or the second clamping element). In an embodiment, when the counterweight is directly or indirectly connected to the connection, the counterweight is no closer to the light-emitting element than the connection. Through the aforementioned implementation, when the lamp device clamps the screen, the counterweight may increase the force of the lamp device abutting against the back surface of the screen, so that the lamp device and the screen are not easily separated from each other. In particular, even if the screen is thin, the lamp device may exert sufficient clamping force to clamp the screen.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A lamp device, comprising:
a light-emitting element;
a first clamping element having a first end and a second end, wherein the first end is connected to the light-emitting element;
a second clamping element has a third end and a fourth end, wherein the third end and the second end are connected at a connection; and
a counterweight connected to the connection;
wherein a distance between the counterweight and the light-emitting element is equal to or greater than a distance between the connection and the light-emitting element; when the lamp device clamps a screen, the fourth end of the second clamping element abuts against a back surface of the screen.

2. The lamp device according to claim 1, wherein the counterweight has a density greater than that of the first clamping element.

3. The lamp device according to claim 1, wherein the second clamping element comprises a first clamping portion and a second clamping portion spaced apart from each other; when the lamp device clamps the screen, the first clamping portion and the second clamping portion abut against the back surface of the screen.

4. A lamp device, comprising:
a light-emitting element;
a first clamping element connected to the light-emitting element; and
a second clamping element connected to the first clamping element and comprising a first clamping portion and a second clamping portion spaced apart from each other;
wherein when the lamp device clamps a screen, the first clamping portion and the second clamping portion respectively abut two different positions at a back surface of the screen.

5. The lamp device according to claim 4, further comprising:
a counterweight disposed adjacent to a connection between the first clamping element and the second clamping element.

6. A lamp device, comprising:
a light-emitting element;
a first clamping element connected to the light-emitting element;
a second clamping element; and
a counterweight disposed on the second clamping element and adjacent to a connection between the first clamping element and the second clamping element;
wherein when the lamp device clamps a screen, the second clamping element abuts against a back surface of the screen.

7. The lamp device according to claim 6, wherein the counterweight pivotally connects the first clamping element with the second clamping element.

8. The lamp device according to claim 6, wherein the counterweight is disposed on an outer lateral surface of the second clamping element, and the counterweight protrudes relative to the outer lateral surface.

9. The lamp device according to claim 6, wherein the second clamping element comprises a first clamping portion and a second clamping portion, and the first clamping portion comprises a first sub-clamping portion and a second sub-clamping portion connected with the first sub-clamping portion, the first sub-clamping portion is rotatably pivoted to the first clamping element around a first axis, the second sub-clamping element is connected with the first sub-clamping element along a second axis, and the second axis is substantially perpendicular to the first axis.

10. A lamp device, comprising:
a light-emitting element;
a first clamping element connected to the light-emitting element, and the first clamping element comprising:
an outer cover; and
a bottom portion, wherein when the outer cover is combined with the bottom portion, an accommodation space is formed;
a second clamping element; and
a counterweight connected to the outer cover and adjacent to a connection between the first clamping element and the second clamping element;
wherein when the lamp device clamps a screen, the second clamping element abuts against a back surface of the screen.

11. The lamp device according to claim 10, further comprising:
a circuit board disposed in the accommodation space and overlapped with the counterweight.

12. A lamp device, comprising:
a light-emitting element;
a first clamping element, comprising:
a neck portion having a first end and a first connection end, wherein the first end is connected to the light-emitting element;
a connection portion having a second connection end, wherein the second connection end is connected to the first connection end of the neck portion;
a front clamping portion connected to the connection portion; and
a circuit module disposed on the neck portion;
a second clamping element connected to a second end of the connection portion; and
a counterweight disposed adjacent to the second end;
wherein when the lamp device clamps a screen, the second clamping element abuts against a back surface of the screen, the front clamping portion abuts against a front surface of the screen, and the circuit module is located between the light-emitting element and the front clamping portion.

13. The lamp device according to claim 12, wherein the circuit module is at least exposed from a surface of the neck portion that is in the same direction with the display surface.

14. The lamp device according to claim 12, wherein the light source further comprises a control circuit, and the circuit module further comprises a sensing circuit electrically connected to the control circuit.
